(19) United States
(12) Patent Application Publication
(10) Pub. No.: US 2008/0313421 A1
(43) Pub. Date: Dec. 18, 2008

(54) LOW POWER-CONSUMPTION DATA PROCESSOR

(75) Inventors: Wen-Chi Hsu, Changhua County (TW); Yu-Kuang Wu, Jhongli City (TW)

Correspondence Address: WPAT, PC, 7225 BEVERLY ST., ANNANDALE, VA, 22003, US

(73) Assignee: HOLTEK SEMICONDUCTOR INC., Hsinchu (TW)

(21) Appl. No.: 12/041,207

(22) Filed: Mar. 3, 2008

(30) Foreign Application Priority Data
Jun. 12, 2007 (TW) 096121134

(51) Int. Cl. G06F 9/00

(52) U.S. Cl. 712/1; 712/E09.001

(57) ABSTRACT

A low power-consumption data processor, wherein instruction decoding is performed on an instruction memory and an instruction register by an instruction decoding unit through an instruction bus, being characterized in that an instruction decoding circuit is disposed between the instruction register, a program counter and an arithmetic logic unit, wherein a new value in an instruction is transmitted on a new instruction bus (NIB) when the decoded result is an operation/jump/call instruction and, otherwise, the new value is transmitted on an original instruction bus (IB).

### BACKGROUND OF THE INVENTION

1. Field of the Invention

The present invention generally relates to a low power-consumption data processor and, more particularly, to a low power-consumption data processor using a method for data dispatch by an instruction decoding circuit according to the type of an instruction. A new value in the instruction is transmitted on a new instruction bus (NIB) when the decoded result is an operation/jump/call instruction. Otherwise, the new value is transmitted on an original instruction bus (IB). The present invention achieves lowered power consumption by instruction classification and data dispatch through different paths.

2. Description of the Prior Art

State of-art electronic products are controlled and/or processed by a micro-controller unit (MCU), a micro-processor unit (MPU) or a digital data processor, while some non-audio electronic products are controlled and/or processed by a digital data processor. It is general that a digital data processor is installed with an instruction decoding circuit so as to decode data and control signals for further processing by an arithmetic logic unit and a data access unit.

In portable electronic products with batteries, it is required that the circuitry is designed for lowered power consumption so that the user does not have replace the batteries too often. Please refer to FIG. 1, which is a functional block diagram of a conventional data processor. The data processor comprises: an instruction memory 11, an instruction register 12, an instruction decoding unit 13, a program counter 14, an arithmetic logic unit 15, a data memory 16, a peripheral circuit 17 and a data bus 18. Instruction decoding is performed on the instruction register 12 by the instruction decoding unit 13 through an instruction bus (IB) 121. The acquired data and control signal (131, 132) are transmitted on the data bus 18 and the instruction bus 121. In such a conventional digital data processor, the new value required by the program counter (PC) 14 and the arithmetic logic unit (ALU) 15 when an operation/jump/call instruction is executed is acquired through the data bus 18. The program counter 14 and the arithmetic logic unit 15 access the data bus 18 so frequently that power consumption is high.

It is believed that power consumption of electronic products is proportional to the operation frequency and complexity of circuitry. In other words, the more complex the circuit or the higher the operation frequency, the more the power consumption.

Therefore, there exists a need in providing a low power-consumption data processor controlling data transmission on the data bus and the instruction bus so as to reduce power consumption by preventing unnecessary circuit operation.

### SUMMARY OF THE INVENTION

It is one object of the present invention to provide a low power-consumption data processor, wherein instruction decoding is performed on an instruction memory and an instruction register by an instruction decoding unit through an instruction bus, being characterized in that an instruction decoding circuit is disposed between the instruction register, a program counter and an arithmetic logic unit, wherein a new value in an instruction is transmitted on a new instruction bus (NIB) when the decoded result is an operation/jump/call instruction and, otherwise, the new value is transmitted on an original instruction bus (IB).

It is another object of the present invention to provide a low power-consumption data processor, wherein the bit of the instruction bus corresponding to the new value is maintained after a new value instruction is decoded so that the number of circuit elements connected to the instruction bus is reduced to further reduce power consumption.

In order to achieve the foregoing objects, the present invention provides a decoding process of a low power-consumption data processor, comprising steps of:
a. pre-decoding an instruction register;
b. determining whether data in the instruction register is a new value instruction;
c. remaining a new instruction bus value, and storing an instruction bus value from instruction memory;
d. storing a new value from an instruction to a new instruction bus, and remaining the instruction bus value;
e. transmitting data from an instruction bus to an instruction decoding unit for decoding;
f. classifying a new value instruction;
g. transmitting the instruction to a program counter if the new value instruction is a jump/call instruction; and
h. transmitting the instruction to an arithmetic logic unit if the new value instruction is an operation instruction.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a functional block diagram of a conventional data processor;

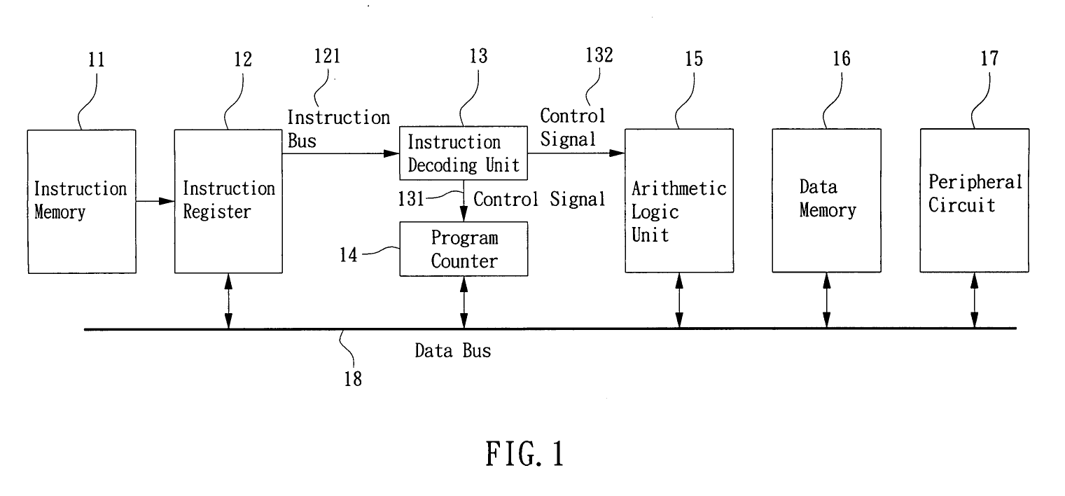

FIG. 2 is a functional block diagram of a low power-consumption data processor according to the present invention; and

FIG. 3 is a flowchart showing a decoding process of a low power-consumption data processor according to the present invention.

### DETAILED DESCRIPTION OF THE PREFERRED EMBODIMENT

The present invention providing a method for resetting a micro-controller can be exemplified by the preferred embodiment as described hereinafter.

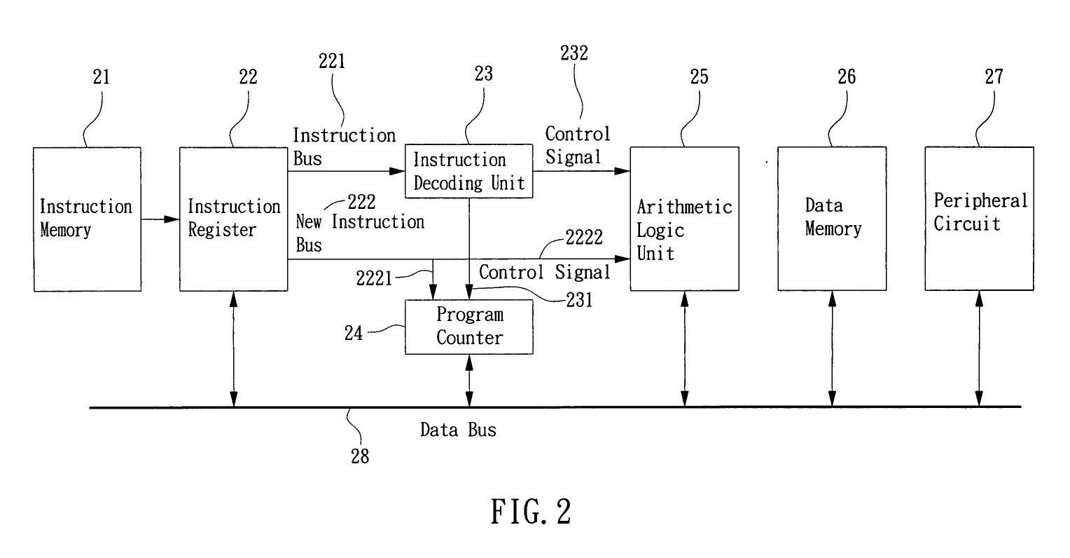

Please refer to FIG. 2, which is a functional block diagram of a low power-consumption data processor according to the present invention. In FIG. 2, the low power-consumption data processor comprises: an instruction memory 21, an instruction register 22, an instruction decoding unit 23, a program counter 24, an arithmetic logic unit 25, a data memory 26, a peripheral circuit 27 and a data bus 28. Since the data memory 26 and the peripheral circuit 27 are similar to those installed in a general digital data processor, the descriptions thereof are not repeated here. The instruction decoding unit 23 performs instruction decoding on the instruction register 22 through the instruction bus 221 to acquire data and control signals 2221, 2222. An instruction decoding unit 23 is disposed between the instruction register 22, the program counter 24 and the arithmetic logic unit 25. A new instruction bus (NIB) 222 carries the control signal 2221 to the program counter 24 and the control signal 2222 to the arithmetic logic unit 25. If the new value instruction is a jump/call instruction, the new instruction bus (NIB) 222 transmits the instruction to the program counter 24, which uses the new value as a new instruction address. On the contrary, if the new value instruction is an operation instruction, the new instruction bus (NIB) 222 transmits the instruction to the arithmetic logic unit 25, which operates according to the new value.

The instruction register 12 is capable of loading data from the instruction memory 11 and performs primary decoding. The program counter 14 is capable of outputting addresses to the instruction memory 11 to control execution of programs. The arithmetic logic unit 15 is capable of performing operation on input data.

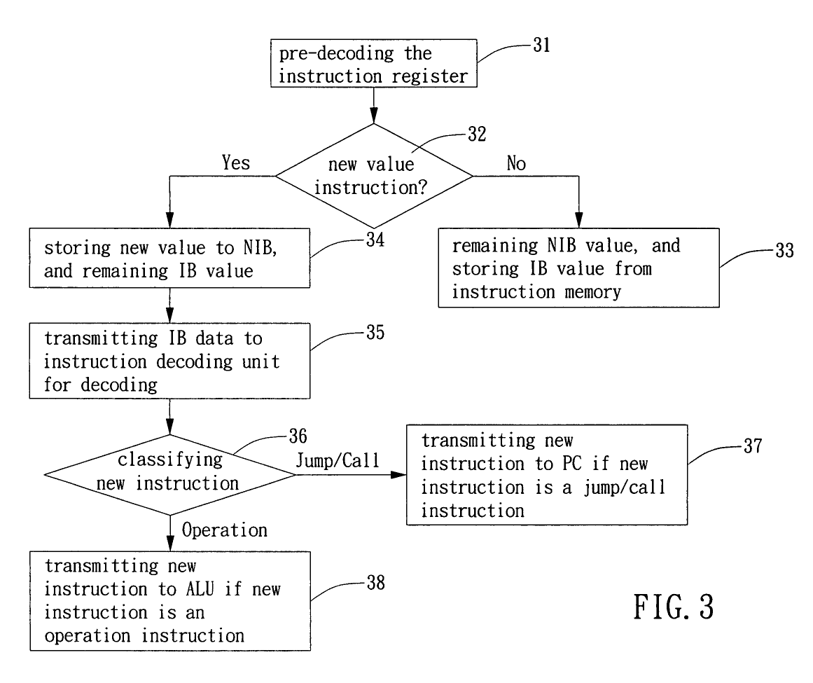

Please refer to FIG. 3, which is a flowchart showing a decoding process of a low power-consumption data processor according to the present invention. The decoding process comprises step as described hereinafter:

In Step 31, an instruction register is pre-decoded.

In Step 32, it is determined whether data in the instruction register is a new value instruction according to a bit in the data in the instruction register. The decoding process performs Step 34 if the determined result in Step 32 is a new value instruction or Step 33 if the determined result in Step 32 is not a new value instruction.

In Step 33, a new instruction bus value is remained, and an instruction bus value is stored from instruction memory.

In Step 34, a new value is stored from an instruction to a new instruction bus, and the instruction bus value is remained.

In Step 35, data is transmitted from an instruction bus to an instruction decoding unit for decoding.

In Step 36, a new value instruction is classified.

In Step 37, if the new value instruction is a jump/call instruction, the new instruction bus (NIB) transmits the instruction to the program counter.

In Step 38, On the contrary, if the new value instruction is an operation instruction, the new instruction bus (NIB) 222 transmits the instruction to the arithmetic logic unit 25.

Therefore, from FIG. 2 and FIG. 3, it is known that the present invention is advantageous that the new value stored in the instruction is used by the arithmetic logic unit and program counter without accessing through the data bus. Moreover, the bit of the instruction bus corresponding to the new value is maintained after a new value instruction is decoded so that the number of circuit elements connected to the instruction bus is reduced to further reduce power consumption.

Accordingly, the present invention discloses a low power-consumption data processor to achieve lowered power consumption by instruction classification and data dispatch through different paths. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A low power-consumption data processor, wherein instruction decoding is performed on an instruction memory and an instruction register by an instruction decoding unit through an instruction bus, being characterized in that an instruction decoding circuit is disposed between the instruction register, a program counter and an arithmetic logic unit, wherein a new value in an instruction is transmitted on a new instruction bus (NIB) when the decoded result is an operation/jump/call instruction and, otherwise, the new value is transmitted on an original instruction bus (IB).

2. The low power-consumption data processor as recited in claim 1, wherein the instruction register is capable of loading data from the instruction memory and performs primary decoding.

3. The low power-consumption data processor as recited in claim 1, wherein the program counter is capable of outputting addresses to the instruction memory to control execution of programs.

4. The low power-consumption data processor as recited in claim 1, wherein the arithmetic logic unit is capable of performing operation on input data.

5. The low power-consumption data processor as recited in claim 1, further comprising a data memory and a peripheral circuit.

6. A decoding process of a low power-consumption data processor, comprising steps of:
a. pre-decoding an instruction register;
b. determining whether data in the instruction register is a new value instruction;
c. remaining a new instruction bus value, and storing an instruction bus value from instruction memory;
d. storing a new value from an instruction to a new instruction bus, and remaining the instruction bus value;
e. transmitting data from an instruction bus to an instruction decoding unit for decoding;
f. classifying a new value instruction;
g. transmitting the instruction to a program counter if the new value instruction is a jump/call instruction; and
h. transmitting the instruction to an arithmetic logic unit if the new value instruction is an operation instruction.

7. The decoding process of a low power-consumption data processor as recited in claim 6, wherein the decoding process performs step d if the determined result in step b is a new value instruction or step c if the determined result in step b is not a new value instruction.

8. The decoding process of a low power-consumption data processor as recited in claim 6, wherein step b is performed according to a bit in the data in the instruction register.
